(19) United States
(12) Patent Application Publication
(10) Pub. No.: US 2020/0255116 A1
(43) Pub. Date: Aug. 13, 2020

(54) AIRCRAFT HINGE APPARATUS AND RELATED METHODS FOR THE SAME

(71) Applicant: Harper Engineering Co., Renton, WA (US)

(72) Inventor: David Chadwell, Renton, WA (US)

(21) Appl. No.: 16/781,739

(22) Filed: Feb. 4, 2020

Related U.S. Application Data
(60) Provisional application No. 62/802,595, filed on Feb. 7, 2019.

(51) Int. Cl. B64C 1/14; E05D 3/12

(52) U.S. Cl. CPC B64C 1/1407; E05D 11/0018; E05Y 2900/502; E05D 3/12

(57) ABSTRACT

A hinge apparatus can include a frame component of an aircraft interior component; a door component coupled to an aircraft door assembly; and a hinge assembly coupled to the frame component and the door component. The hinge assembly can be operable between an open configuration, an intermediate configuration, and a closed configuration. The hinge assembly may include a first hinge body, and a second hinge body coupled to the door component, the second hinge body pivotably moving the door component about a first pivot point when the hinge assembly moves from the closed configuration to the intermediate configuration, and the second hinge body moving the door component about a second pivot point that is different from the first pivot point when the hinge assembly moves from the intermediate configuration to the open configuration. Related methods are also provided.

### BACKGROUND

### Technical Field

The present disclosure generally relates to aircraft interior components and, more particularly, to aircraft interior component hinges.

### Description of the Related Art

Aircraft generally include a wide variety of interior components. Aircraft interior components, for example, galley doors, passenger service units, lavatory doors, galleys, closets, and other interior furnishings generally are hingedly moveable between open and closed positions. In general, such interior furnishings may include a door component and a door jamb or frame. The door component is generally moveable hingedly about the door jamb.

In many aircraft applications, it is desirable to provide a larger rotary radius, while at the same time concealing components of the hinge assembly to improve aesthetic appeal when the aircraft component is in a closed configuration.

### BRIEF SUMMARY

Various implementations of hinge apparatuses described herein improve efficiencies and aesthetic appeals, while improving rotary radiuses of the hinge apparatus. For example, in one non-limiting, example implementation, a hinge apparatus can be summarized as including a frame component of an aircraft interior component; a door component coupled to an aircraft door assembly; and a hinge assembly coupled to the frame component and the door component. The hinge assembly can be operable between an open configuration, an intermediate configuration, and a closed configuration. The hinge assembly may include a first hinge body; and a second hinge body coupled to the door component, the second hinge body pivotably moving the door component about a first pivot point when the hinge assembly moves from the closed configuration to the intermediate configuration, and the second hinge body moving the door component about a second pivot point that is different from the first pivot point when the hinge assembly moves from the intermediate configuration to the open configuration.

In another non-limiting, example implementation, a method for operating an aircraft door can be summarized as including coupling a frame component of a hinge apparatus to an aircraft door frame; coupling a door component of the hinge apparatus to the aircraft door; and operating the aircraft door between open, closed, and intermediate configurations. The operating may include pivotably moving the door component between the closed and intermediate configurations about a first pivot point, and pivotably moving the door component between the intermediate and open configurations about a second pivot point, the second pivot point being different from the first pivot point.

### BRIEF DESCRIPTION OF THE SEVERAL VIEWS OF THE DRAWINGS

FIG. 1 is an isometric view of a hinge apparatus in a closed configuration, according to one example, non-limiting implementation.

FIG. 2 is an isometric view of the hinge apparatus of FIG. 1, with certain components, e.g., door and frame components, removed for clarity of illustration and description.

FIG. 3 is an exploded view of the hinge apparatus of FIG. 1.

FIG. 4 is a cross-sectional view of the hinge apparatus of FIG. 1, taken along lines 4-4.

FIG. 5 is an isometric view of the hinge apparatus of FIG. 1 in an intermediate configuration.

FIG. 6 is a cross-sectional view of the hinge apparatus of FIG. 1, taken along lines 6-6.

FIG. 7 is an isometric view of the hinge apparatus of FIG. 1 in an open configuration.

FIG. 8 is an isometric view of the hinge apparatus of FIG. 1, with certain components e.g., door and frame components, removed for clarity of illustration and description.

FIG. 9 is a cross-sectional view of the hinge apparatus of FIG. 1, taken along lines 9-9.

### DETAILED DESCRIPTION

In the following description, certain specific details are set forth in order to provide a thorough understanding of various disclosed embodiments or implementations. However, one skilled in the relevant art will recognize that embodiments or implementations may be practiced without one or more of these specific details, or with other methods, components, materials, etc. In other instances, well-known structures associated with payload components, hinges, latches, aircraft interior furnishings, aircraft doors, aircraft frames, or other systems and apparatuses of aircrafts have not been shown or described in detail to avoid unnecessarily obscuring descriptions of the embodiments or implementations.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment,” “one implementation,” “an embodiment,” or “an implementation” means that a particular feature, structure or characteristic described in connection with the embodiment or implementation is included in at least one embodiment or implementation. Thus, the appearances of the phrases “in one embodiment,” “in one implementation,” “in an embodiment,” or “in an implementation” in various places throughout this specification are not necessarily all referring to the same embodiment or implementation. Furthermore, the particular features, structures, or characteristics may be combined in any suitable manner in one or more embodiments or implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

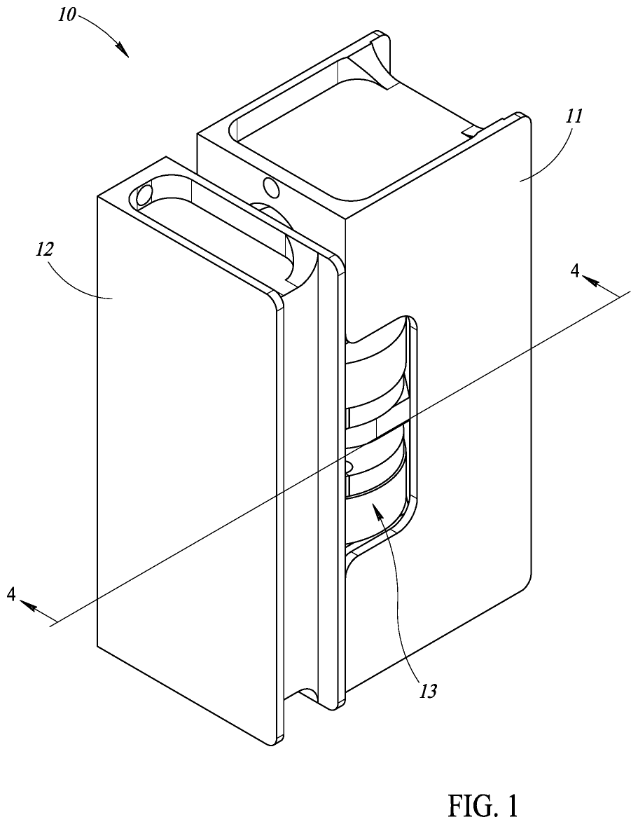

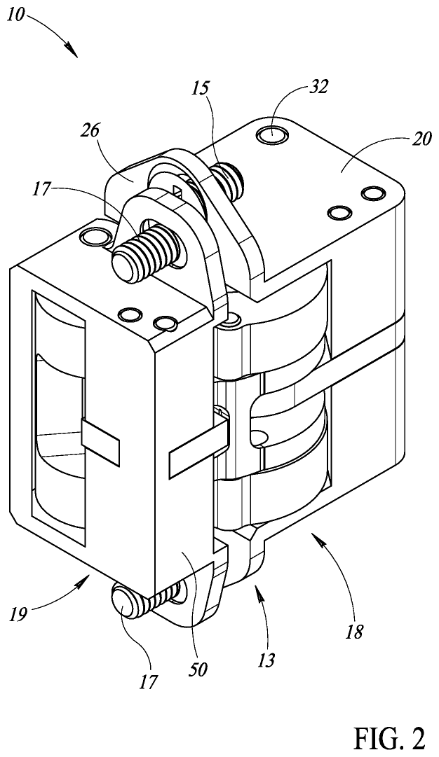

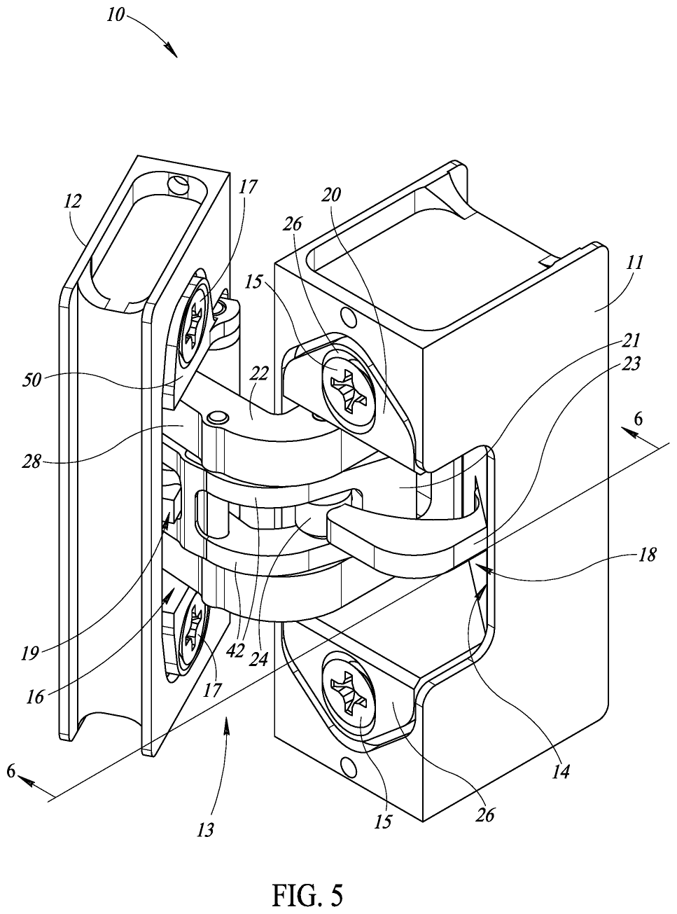

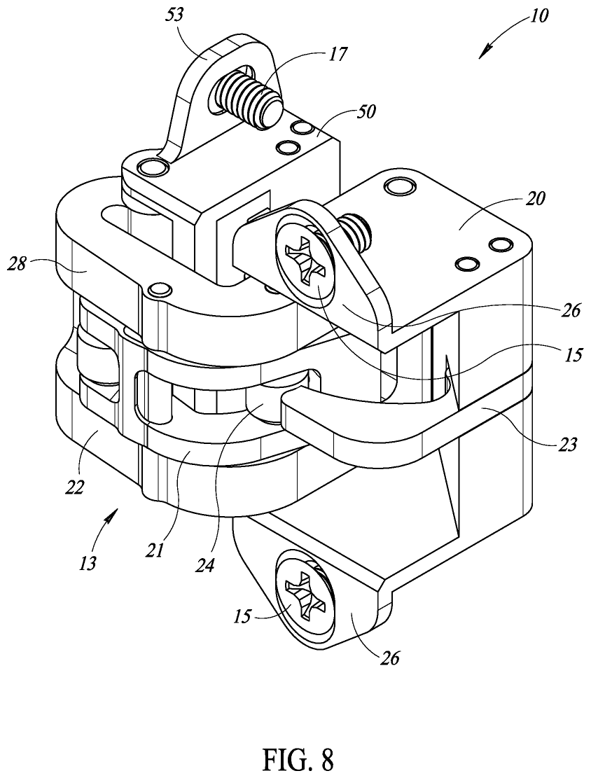

FIGS. 1-9 illustrate a hinge apparatus 10, according to one example, non-limiting implementation. The hinge apparatus 10 is moveable between a closed configuration, an open configuration, and an intermediate configuration. As described in more detail herein, the hinge apparatus 10 is generally operable to conceal various components thereof when in the closed configuration while providing for rotary capability that allows for an extended rotary movement.

The hinge apparatus 10 includes a frame component 11, a door component 12, and a hinge assembly 13. In general, the frame component 11 is generally sized and shaped to couple the hinge assembly 13 to a frame structure of an aircraft. For example, the frame component 11 may comprise a door jamb or other frame structure of an aircraft. The frame component 11 includes a first hinge recess 14 that is sized and shaped to receive therein the hinge assembly 13 or, more particularly, certain portions of the hinge assembly 13. As described in more detail below, the frame component 11 is generally coupled to the hinge assembly 13 via one or more first fasteners 15.

The door component 12, in general, is sized and shaped to couple to a door of an aircraft. For example, the door may comprise a lavatory door, an aircraft galley door, a closet door, or other interior furnishing component that closes and opens to provide access to an interior volume of such components. The door component 12 also includes a second hinge recess 16 that is sized and shaped to receive therein the hinge assembly 13 or, more particularly, certain portions of the hinge assembly 13. As described in more detail below, the door component 12 is generally coupled to the hinge assembly 13 via one or more second fasteners 17.

The hinge assembly 13 is generally sized, shaped, and arranged to increase a rotary movement of the door component 12, while concealing the hinge assembly 13 when in the closed configuration. For example, as illustrated in FIG. 1, when the hinge apparatus 10 is in the closed configuration, the interior components of the hinge assembly 13 are generally not exposed. Moreover, such extended rotary movement of the door component 12 may comprise rotary or pivotable movement about a plurality of rotary or pivot points. As such, the door component 12 may pivotably move from an initial position to a terminal position in which the door component 12 may rotate at least about 270 degrees.

The hinge assembly 13 includes a frame assembly 18 and a door assembly 19. The frame assembly 18 is generally sized and shaped to couple to the frame component 11 and the door assembly 19 is generally sized and shaped to couple to the door component 12.

In particular, the frame assembly 18 includes a first hinge body 20, a shuttle 21, a hinge arm 22, a first catch 23, a first roller 24, and a biasing device 25. The first hinge body 20 includes a pair of tabs 26 and is sized and shaped to be received in the first hinge recess 14. The tabs 26 include apertures that are sized and shaped to receive the first fasteners 15, which couple the first hinge body 20 to the frame component 11. The first hinge body 20 includes a first interior cavity 27 that is sized and shaped to receive the shuttle 21 and the hinge arm 22. In particular, the hinge arm 22 includes a pair of arms 28 that are spaced apart from each other and extend from a first end portion 29 to a second end portion 30. The first end portion 29 includes a first pin aperture 31 that is sized and shaped to pivotably couple the hinge arm 22 to move about the first hinge body 20 via a first hinge pin 32, e.g., pivot point P₁. In this manner, the hinge arm 22 may pivotably rotate relative to first hinge body 20 about pivot point P₁.

Each arm 28 includes a respective pin slot 33. Each pin slot 33 is generally elongated and sized and shaped to moveably couple the hinge arm 22 to the shuttle 21 and the first roller 24 via a first arm pin 34. In particular, the shuttle 21 includes a straight shuttle aperture 35 and the first roller 24 includes a straight first roller aperture 36 through which the first arm pin 34 is coupleably received. Each pin slot 33 is sized and shaped to allow the shuttle 21 and the first roller 24 to move relative to the hinge arm 22 along a travel path defined by each pin slot 33. In this manner, the shuttle 21 and the first roller 24 may move relative to the hinge arm 22 along the travel path defined by each pin slot 33.

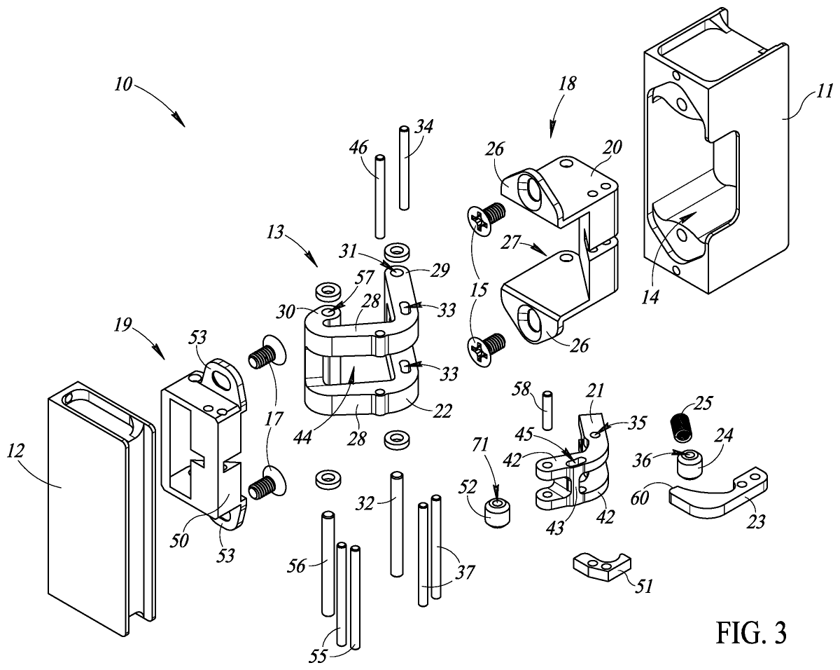

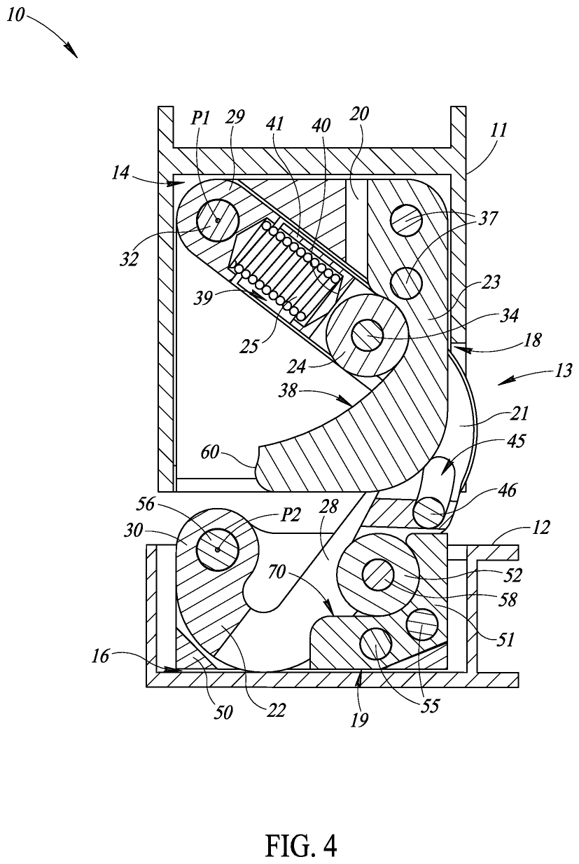

As illustrated in FIGS. 3-9, for example, the first catch 23 has an angular orientation, forming a substantially hook-shaped structure, although it is to be appreciated that other shapes and sizes are within the scope of the disclosed subject matter. The first catch 23 is fixedly coupled to the first hinge body 20 via one or more first catch pins 37. An interior surface 38 of the first catch 23 is sized and shaped to allow the first roller 24 to move along the interior surface 38. In particular, in a first position illustrated in particularity in FIG. 4, the first roller 24 is positioned proximate to the one or more first catch pins 37 and positioned to engage the interior surface 38 to latch the hinge assembly 13.

The biasing device 25, e.g., a compression spring, is generally configured to urge the shuttle 21 away from the pivot point P₁. In particular, the shuttle 21 includes a spring cavity 39 that is sized and shaped to receive the biasing device 25. The shuttle 21 includes an end portion 40 and a side wall 41. The biasing device 25 is positioned in the spring cavity 39 and faces the end portion 40 to urge the shuttle 21 away from the pivot point P₁. As described above, the first roller 24, however, is engaged with, or latched to, the first catch 23, which provides a friction force that opposes the biasing force applied by the biasing device 25.

The shuttle 21 also includes a pair of shuttle arms 42 that are spaced apart from each other by a web 43. The shuttle 21 is sized and shaped to be received in a shuttle cavity 44 disposed in the hinge arm 22. Each shuttle arm 42 includes a shuttle slot 45 that is generally elongated and sized and shaped to moveably couple the hinge arm 22 to the shuttle 21. A shuttle pin 46 couples the shuttle 21 to the hinge arm 22. In this manner, the shuttle 21 may move relative to the hinge arm 22 along the travel path defined by each shuttle slot 45.

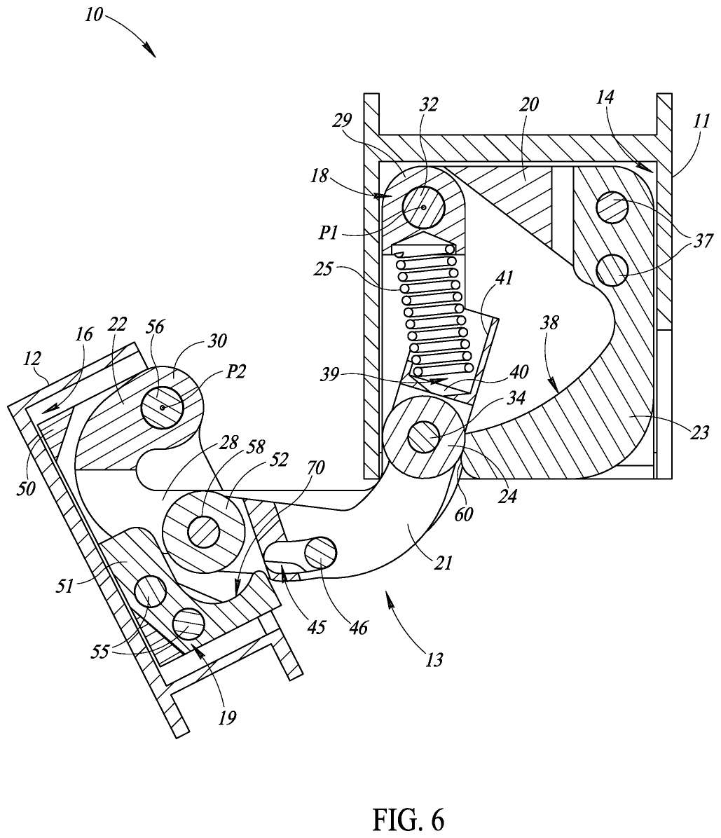

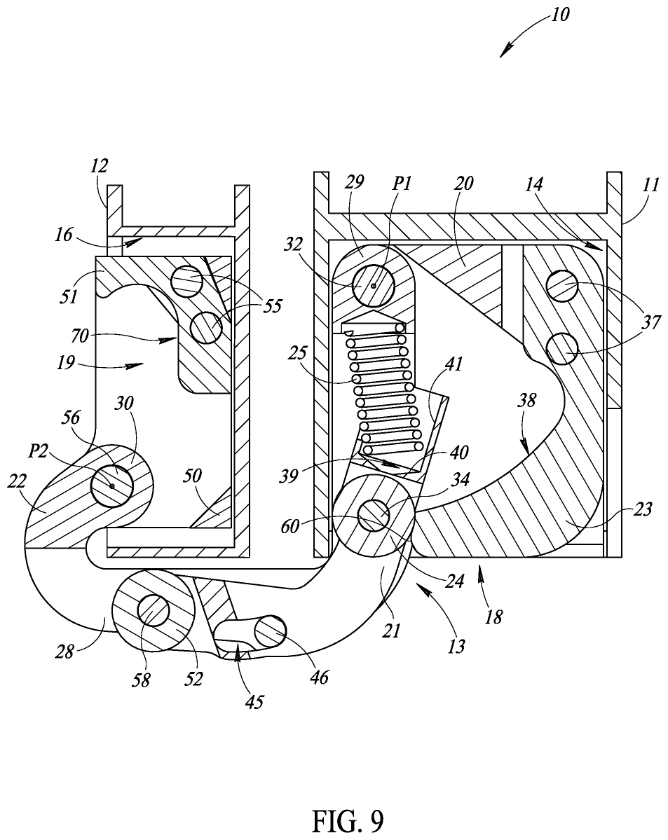

As described above, the first roller 24 is sized and shaped to move along the interior surface 38 of the first catch 23. The first roller 24 is coupled to the shuttle 21 and the hinge arm 22 via the first arm pin 34. In particular, movement of the hinge arm 22 causes the shuttle 21 and the first roller 24 to move therewith, which moves the first roller 24 from the first position, e.g., when the first roller 24 is engaged with the first catch 23, to a second position, in which the first roller 24 is disengaged from the first catch 23, as illustrated in FIGS. 6 and 9 in more detail.

The door assembly 19 of the hinge assembly 13 includes a second hinge body 50, a second catch 51, and a second roller 52. The second hinge body 50 includes a pair of door tabs 53 and is sized and shaped to be received in the second hinge recess 16. The door tabs 53 include apertures that are sized and shaped to receive the second fasteners 17. As described above, the hinge arm 22 includes the second end portion 30. The second end portion 30 is sized and shaped to pivotably couple hinge arm 22 to the second hinge body 50 via a second hinge pin 56 that is received in a second pin aperture 57. In this manner, the hinge arm 22 may pivotably rotate relative to second hinge body 50 about pivot point P₂.

As illustrated in FIGS. 3-9, for example, the second catch 51 has an angular orientation, forming a substantially hook-shaped structure, although it can be appreciated that other shapes and sizes are within the scope of the disclosed subject matter. The second catch 51 is fixedly coupled to the second hinge body 50 via one or more second catch pins 55. An interior surface 70 of the second catch 51 is sized and shaped to allow the second roller 52 to move along and/or away from the interior surface 70. In particular, in a first position illustrated in FIG. 4 in particularity, the second roller 52 is positioned proximate to the one or more second catch pins 55 and positioned to engage the interior surface 70 to latch the hinge assembly 13.

As described above, the second roller 52 is sized and shaped to move along and/or away from the interior surface 70 of the second catch 51. The second roller 52 is fixedly coupled to the shuttle 21 via a roller pin 58 that is received in a straight second roller aperture 71 disposed in the second roller 52. In this manner, movement of the shuttle 21 causes the second roller 52 to move therewith. In particular, movement of the shuttle 21 causes the second roller 52 to move therewith, which moves the second roller 52 from the first position, e.g., when the second roller 52 is engaged with the second catch 51 illustrated with particularity in FIG. 4, to a second position(s), in which the second roller 52 disengages from the second catch 51.

With continued reference to FIGS. 1-9, and specific reference to FIGS. 4, 6, and 9, in operation, the hinge apparatus 10 is generally operable for the door component 12 to move between closed and open positions and/or configurations. In particular, as shown in FIG. 4, in the closed configuration, the door component 12 and/or the hinge assembly 13 is in a latched or closed configuration where the first roller 24 is positioned in the first catch 23 and is latched and/or in engagement with the interior surface 38. Further, the second roller 52 is positioned in the second catch 51 and is latched and/or in engagement with the interior surface 70. As the door component 12 is moved, for example, if a door assembly or parts thereof, coupled to the door component 12, is moved, such causes the hinge arm 22 and the shuttle 21 to move. In particular, second hinge body 50 pivotably moves about pivot point P₁ and/or first hinge pin 32. The pivotable movement of the second hinge body 50 causes the hinge arm 22 to pivotably rotate about the first hinge pin 32 and/or pivot point P₁. As described above, the shuttle 21 and the first roller 24 are coupled to the hinge arm 22, and when the hinge arm 22 moves, such cause the first roller 24 to move along the interior surface 38 of the first catch 23. As the first roller 24 moves out of the latched position, e.g., out of the first position, the biasing device 25 urges the first roller 24 away from the pivot point P₁.

Further, as illustrated in FIGS. 4 and 6, as the door component 12 is rotatably moved, the hinge arm 22 continues to pivotably move about first hinge pin 32 and/or pivot point P₁, which causes the second roller 52 to disengage and move from its first position to the second position, in which the second roller 52 disengages from the second catch 51.

FIG. 6 shows the hinge apparatus 10 when the hinge assembly 13 is in an intermediate configuration, upon rotation of the door component 12 described above. As shown in FIG. 6, in the intermediate configuration, the shuttle 21 is latched and the first roller 24 engages or abuts an end 60 of the first catch 23. In this manner, the frictional force between an outer surface of the first roller 24 and the end 60 of the first catch 23 and the biasing force of the biasing device 25 restricts, limits, and/or prevents the shuttle 21 from further pivotable movement. Further, because of the frictional and biasing forces described above, the hinge arm 22 is also restricted, limited, and/or preventing from further pivotable movement. In other words, the hinge arm 22 is latched when the hinge assembly 13 is in the intermediate configuration.

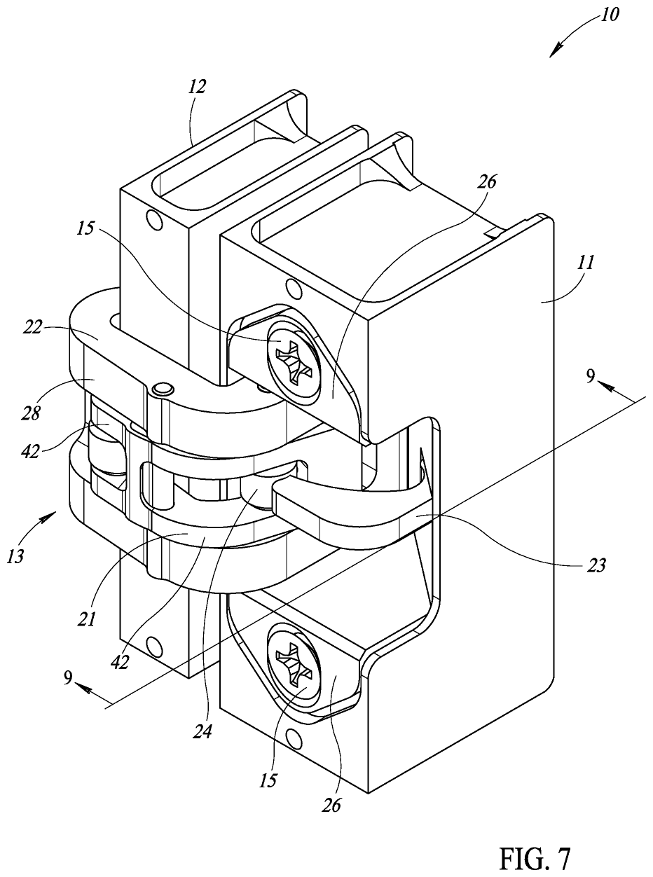

FIG. 7 shows the hinge apparatus 10 when the hinge assembly 13 is in the open configuration. In particular, as described above, in the intermediate configuration, the hinge arm 22 is latched. As the door component 12 continues to be moved, such causes the second hinge body 50 to pivotably rotate about the second hinge pin 56 and/or pivot point P₂. As shown in FIG. 7, the second hinge body 50 and the door component 12 coupled thereto moves from its initial position illustrated in FIGS. 1, 2, and 4 when the hinge apparatus 13 is in the closed configuration to a position illustrated in FIG. 7 in which the door component 12 and the second hinge body 50 has rotated about 270 degrees.

As the door component 12 is returned to the closed position from the open position illustrated in FIG. 7, rotation of the door component 12 in a reverse direction causes the hinge assembly 13 to move from the open configuration to the intermediate configuration to the closed configuration. In particular, as the door component 12 rotates in the reverse direction, the second hinge body 50 pivotably rotates about the second hinge pin 56 and/or pivot point P₂. Such rotation causes the second roller 52 to engage the interior surface 70 of the second catch 51. In other words, the second hinge body 50 is returned to be latched to the hinge arm 22. As the door component 12 continues to rotate, such causes the frictional forces and the biasing forces applied to the first roller 24 by the first catch 23 to be overcome, and the first roller 24 is moved to engagement with the interior surface 38 of the first catch 23. Continued movement of the door component 12 returns the door component 12 to the closed position as the hinge assembly 13 moves to the closed configuration.

Moreover, the various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A hinge apparatus, comprising:
a frame component of an aircraft interior component;
a door component coupled to an aircraft door assembly; and
a hinge assembly coupled to the frame component and the door component, the hinge assembly operable between an open configuration, an intermediate configuration, and a closed configuration, the hinge assembly including:
a first hinge body; and
a second hinge body coupled to the door component, the second hinge body pivotably moving the door component about a first pivot point when the hinge assembly moves from the closed configuration to the intermediate configuration, and the second hinge body moving the door component about a second pivot point that is different from the first pivot point when the hinge assembly moves from the intermediate configuration to the open configuration.

2. The hinge apparatus of claim 1 wherein the hinge assembly comprises:
a first catch fixedly coupled to the first hinge body and having an interior surface; and
a first roller, the first roller arranged to engage with the interior surface of the first catch when the hinge assembly is in the closed configuration.

3. The hinge apparatus of claim 2 wherein the hinge assembly comprises:
a second catch fixedly coupled to the second hinge body and having an interior surface; and
a second roller, the second roller arranged to engage with the interior surface of the second catch when the hinge assembly is in the closed configuration.

4. The hinge apparatus of claim 2 wherein the hinge assembly comprises:
a biasing device positioned in the first hinge body, the biasing device sized and shaped to urge the first roller to move along the interior surface of the first catch.

5. The hinge apparatus of claim 4 wherein the first catch includes a catch end that engages the first roller when the hinge assembly is in the intermediate configuration.

6. The hinge apparatus of claim 1 wherein the hinge assembly comprises:
a hinge arm including a first end portion and a second end portion, the first end portion coupled to the first hinge body via a first pin, the first pin defining the first pivot point, and the second end portion coupled to the second hinge body via a second pin, the second pin defining the second pivot point.

7. The hinge apparatus of claim 6 wherein the hinge assembly comprises:
a shuttle that is coupled to the hinge arm, the shuttle sized and shaped to move with the hinge arm when the hinge assembly moves from the closed configuration to the open configuration.

8. The hinge apparatus of claim 7 wherein the hinge assembly comprises:
a first catch fixedly coupled to the first hinge body and having an interior surface; and
a first roller coupled to the shuttle, movement of the shuttle causing the first roller to move along the interior surface of the first catch when the hinge assembly moves between the closed configuration and the intermediate configuration.

9. The hinge apparatus of claim 8 wherein the hinge assembly comprises:
a second catch fixedly coupled to the second hinge body and having an interior surface; and
a second roller, movement of the shuttle causing the second roller to disengage from the interior surface of the second catch when the hinge assembly moves between the closed configuration and the intermediate configuration.

10. The hinge apparatus of claim 1 wherein pivotable movement of the door component about the first pivot point, when the hinge assembly moves from the closed configuration to the intermediate configuration, causes the door component to rotate at an obtuse angle.

11. A method for operating an aircraft door, the method comprising:
coupling a frame component of a hinge apparatus to an aircraft door frame;
coupling a door component of the hinge apparatus to the aircraft door; and
operating the aircraft door between open, closed, and intermediate configurations, the operating including:
pivotably moving the door component between the closed and intermediate configurations about a first pivot point; and
pivotably moving the door component between the intermediate and open configurations about a second pivot point, the second pivot point being different from the first pivot point.

12. The method of claim 11, comprising:
coupling a first hinge body of the hinge apparatus to the frame component; and
coupling a second hinge body of the hinge apparatus to the door component, pivotable movement of the door component between the closed and intermediate configurations causing the second hinge body to move about the first pivot point, and pivotable movement of the door component between the intermediate and closed configurations causing the second hinge body to move about the second pivot point.

13. The method of claim 12, comprising:
coupling a hinge arm having a first end portion and a second end portion to the first hinge body and the second hinge body, respectively, by coupling the first end portion to the first hinge body via a first pin, and coupling the second end portion to the second hinge body via a second pin.

14. The method of claim 11, comprising:
engaging a first roller of the hinge apparatus to a first catch of the hinge apparatus to latch the hinge apparatus when the door component is in the closed configuration; and
engaging a second roller of the hinge apparatus to a second catch of the hinge apparatus to latch the hinge apparatus when the door component is in the closed configuration.

15. The method of claim 14, comprising:
disengaging the second roller of the hinge apparatus from the second catch of the hinge apparatus to unlatch the hinge apparatus when the door component is in the intermediate configuration.
